(19) United States
(12) Patent Application Publication
(10) Pub. No.: US 2013/0208375 A1
(43) Pub. Date: Aug. 15, 2013

(54) MIRROR AND METHODS OF MAKING THE SAME

(71) Applicant: GUARDIAN INDUSTRIES CORP., (US)

(72) Inventors: Alexey KRASNOV, Canton, MI (US); Willem DEN BOER, Brighton, MI (US); Philip J. LINGLE, Temperance, MI (US)

(73) Assignee: GUARDIAN INDUSTRIES CORP., Auburn Hills, MI (US)

(21) Appl. No.: 13/754,025

(22) Filed: Jan. 30, 2013

Related U.S. Application Data
(63) Continuation-in-part of application No. 13/338,644, filed on Dec. 28, 2011.

(51) Int. Cl. G02B 1/10

(52) U.S. Cl. CPC G02B 1/105
USPC 359/884; 156/60; 156/250

(57) ABSTRACT

Certain example embodiments of this invention relate to sputtered aluminum second surface mirrors with permanent protective coatings optionally provided thereto, and/or methods of making the same. A mirror coating supported by a substrate may include, for example, first and second dielectric layers sandwiching a metallic or substantially metallic layer including aluminum, and an optional layer including Ni and/or Cr in direct contact with the metallic or substantially metallic layer comprising aluminum. A protective film may be disposed directly over and contacting an outermost layer of the mirror coating, with the protective film having a peel strength of 200-500 cN/20 mm wide strip.

This is a Continuation-in-Part (CIP) of U.S. application Ser. No. 13/338,644, filed Dec. 28, 2011, the disclosure of which is hereby incorporated herein by reference.

Certain example embodiments of this invention relate to second surface mirrors, and/or methods of making the same. More particularly, certain example embodiments relate to sputtered aluminum second surface mirrors with permanent protective coatings optionally provided thereto, and/or methods of making the same. In certain example instances, such mirrors may be used in interior residential, commercial, appliance, and/or other applications, e.g., with very high visible glass side reflectance and very low production-related costs.

### BACKGROUND AND SUMMARY OF EXAMPLE EMBODIMENTS OF THE INVENTION

Mirrors have been in existence for years and have been used in interior building applications such as, for example, in bathrooms, as decorations, etc.; for exterior applications such as, for example, in concentrating solar power (CSP) and concentrating photovoltaic (CPV) applications, as well as in secondary reflector panels (SRPs); as well as handheld vanity and a host of other products. Mirrors generally are either (a) first surface mirrors, where the mirror coating is provided between the viewer and the supporting glass substrate, or (b) second surface mirrors, where the supporting glass substrate is interposed between the viewer and the mirror coating. See, for example, U.S. Pat. Nos. 7,276,289 and 7,678,459; U.S. Publication Nos. 2006/0077580; 2007/0178316; 2008/0073203; 2008/0164173; 2010/0229853; 2011/0176212; and 2011/0176236; as well as U.S. application Ser. No. 12/923,836, filed on Oct. 8, 2010. The entire contents of each of these patent documents are hereby incorporated herein by reference.

Many second surface mirrors include silver-based reflecting layers. Silver is highly reflective in the visible and infrared ranges, therefore making it a good choice from a total reflectance perspective.

Unfortunately, however, silver is quite expensive. It also is not particularly durable and, for example, is subject to corrosion when exposed to even building interior environments. Durability problems can be overcome with silver-inclusive mirrors, however, by applying one or more layers of protective paint. Yet these paints are sometimes expensive and, at a minimum, inject time delays in the process because they need to be coated and dried and sometimes re-coated and re-dried. Wet coating techniques also are “messy” and potentially hazardous to humans.

Thus, it will be appreciated that there is a need in the art for improved mirrors and/or methods of making the same.

In certain example embodiments of this invention, a mirror is provided. A multilayer thin film coating is supported by a substrate, The multilayer thin film coating comprises, in order moving away from the substrate: a first silicon-inclusive layer, a metallic or substantially metallic layer comprising aluminum, a 5-150 angstrom thick layer comprising Ni and/or Cr in direct contact with the metallic or substantially metallic layer comprising aluminum, and a second silicon-inclusive layer in direct contact with the layer comprising Ni and/or Cr. A protective film is disposed directly over and contacting an outermost layer of the multilayer thin film coating, with the protective film having a peel strength of 200-500 cN/20 mm wide strip. The protective film is adapted to survive seven day exposure to an 85 degree C. temperature at 85% relative humidity, as well as seven day exposure to a 49 degree C. temperature at 100% relative humidity.

In certain example embodiments of this invention, there is provided a coated article comprising a substrate and a multilayer thin film coating supported by the substrate. The multilayer thin film coating comprises a metallic or substantially metallic layer comprising aluminum sandwiched between inner and outer silicon-inclusive layers. A protective film is disposed directly over and contacting an outermost layer of the multilayer thin film coating.

In certain example embodiments of this invention, a method of making a coated article is provided. A coating comprising at least the following layers are sputter-deposited on a glass substrate in the following order: a first silicon-inclusive layer, a metallic or substantially metallic layer comprising aluminum, and a second silicon-inclusive layer. A protective film is applied directly over and contacting an outermost layer of the coating, with the protective film having a peel strength of 200-500 cN/20 mm wide strip.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIGS. 1a and 1b show schematic cross-sectional views of second surface mirror coatings in accordance with certain example embodiments of this invention;

FIG. 2 is a graph that plots glass side reflectance versus wavelength for the FIG. 1a example embodiment over the 350-750 nm wavelength range; and

FIG. 3 is a flowchart illustrating an example process for making a mirror in accordance with certain example embodiments.

### DETAILED DESCRIPTION OF EXAMPLE EMBODIMENTS OF THE INVENTION

Certain example embodiments of this invention relate to high performance sputtered aluminum second surface mirrors with permanent protective adhesive films optionally provided thereto, and/or methods of making the same. In certain example instances, such mirrors may be used in interior residential, commercial, appliance, and/or other applications, e.g., where it is desirable to provide very high visible glass side reflectance while keeping associated production costs low.

In certain example embodiments, a coated article is provided. The coated article may comprise a substrate supporting a multi-layer, thin film coating including at least the following layers, in order, moving away from a second surface of the substrate: a first silicon-based layer (e.g., an oxide and/or nitride of silicon), a metallic or substantially metallic reflective layer comprising aluminum, optionally in direct contact with the first silicon-based layer; and a second silicon-based or other dielectric layer (e.g., an oxide and/or nitride of silicon) that serves as a protective layer. The first and second silicon-based layers may consist essentially of the same composition and/or may have substantially the same stoichiometries in certain example embodiments. In certain example embodiments, the first and/or second dielectric layers may be of or include a silicon inclusive based layer such as silicon nitride or silicon oxynitride. In other example embodiments, the first and/or second dielectric layers may be of or include other material such as aluminum oxide, aluminum oxynitride, zirconium oxide, titanium oxide, yittrium oxide, zinc oxide, zinc aluminum oxide, tin oxide or the like. Optionally, a protective barrier layer comprising Ni and/or Cr may be interposed between the reflective layer and the second dielectric layer. A permanent protective film (PPF) may be applied to the film side of this layer stack for added overall durability. The PPF may be applied in solid form in certain example embodiments.

The aluminum-inclusive second surface mirrors of certain example embodiments may be advantageous over conventional silver-based second surface mirrors. For example, the lower material cost for aluminum may result in a reduced cost to coat as compared to a silver-based mirror. Aluminum also is known to have superior chemical, mechanical, and environmental durability as compared to silver. Certain example embodiments also may offer superior adhesion of the reflective metal to a broader range of underlying layers and/or substrates as compared to conventional minors. For instance, aluminum adheres well to silicon-based thin film layers, whereas silver growth is known to benefit from the presence of seed layers (e.g., of or including zinc oxide and/or an optionally oxidized Ni and/or Cr inclusive layer) in terms of both adhesion and uniformity. Aluminum also better adheres to bare glass than silver. The reflective optical properties for aluminum are also very similar to silver, even though aluminum is advantageous in the above-described and/or other ways.

Some current second surface mirrors incorporate a protective paint on the film side of the coated article. The protective paint is intended to increase chemical, mechanical, and environmental durability. This protective paint can be particularly important where silver-based sputter deposited second surface minors are concerned, as the silver can be damaged very easily, e.g., via scratching or marring, via oxidation through normal environmental exposure or inadvertent chemical attack, etc. By contrast, certain example embodiments replace the typically used protective paint with a permanent protective film. The removal of the paint and replacement with a permanent protective film can actually lower the cost of the final product while also conferring a number of other advantages. For example, costly paint application hardware and drying systems can be replaced with lower-cost roll application of the permanent protective plastic film. This, in turn, may impart a substantial increase in throughput speed as compared to protective paints, e.g., because application may be simplified and drying/curing steps may be removed. There also is an opportunity to substantially reduce environmentally hazardous waste, thereby possibly also reducing clean room, maintenance, and disposal costs. The roll application technique also may reduce labor and utility costs, while also offering savings in safety related fabrication costs. For instance, protective paints oftentimes necessitate risk management procedures associated with, for example, chemical storage, application, training, personal protective equipment (PPE), etc.

The protective film may also help enhance the safety of the final product as compared to existing mirrors with standard protective paints. For instance, plastic protective films tend to better trap and/or contain material that may flake or otherwise come off. This also applies to glass shards that may result if the mirror is broken. The paints also may be hazardous when ingested or exposed to the skin, whereas plastic protective films may be harmful only in much larger doses.

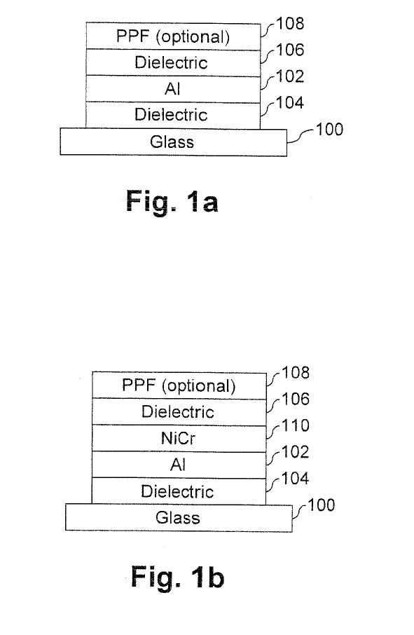

FIGS. 1a and 1b show schematic cross-sectional views of second surface mirror coatings in accordance with certain example embodiments of this invention. The mirrors in FIGS. 1a-1b are second surface mirrors, because the incident light passes through the substrate 100 before being reflected by the mirror's aluminum based reflective layer 102. As shown in FIG. 1a, a glass substrate 100 supports a mirror coating including plural sputter-deposited thin film coatings and an optional PPF. More particularly, as shown in FIG. 1a, an Al-based metallic layer 102 is sandwiched between first and second layers including silicon nitride (e.g., Si₃N₄ or other suitable stoichiometry) 104 and 106. A PPF film 108 is optionally provided as an outermost protective coating. The Al-based metallic layer may be a “3-9s purity” or commercial grade T6061 aluminum alloy in certain example instances. In the FIG. 1a example, the Al-based metallic layer 102 is in direct contact with the first and second layers including silicon nitride 104 and 106 or of other dielectric material.

The layer stack design shown in FIG. 1b is identical to the FIG. 1a design, except that a layer including Ni and/or Cr 110 (NiCr in the FIG. 1b example) has been added. This layer including Ni and/or Cr 110 may be used to increase chemical, mechanical, and environmental durability, as may be the case when the aluminum mirror stack is provided without the optional permanent protective plastic film 108.

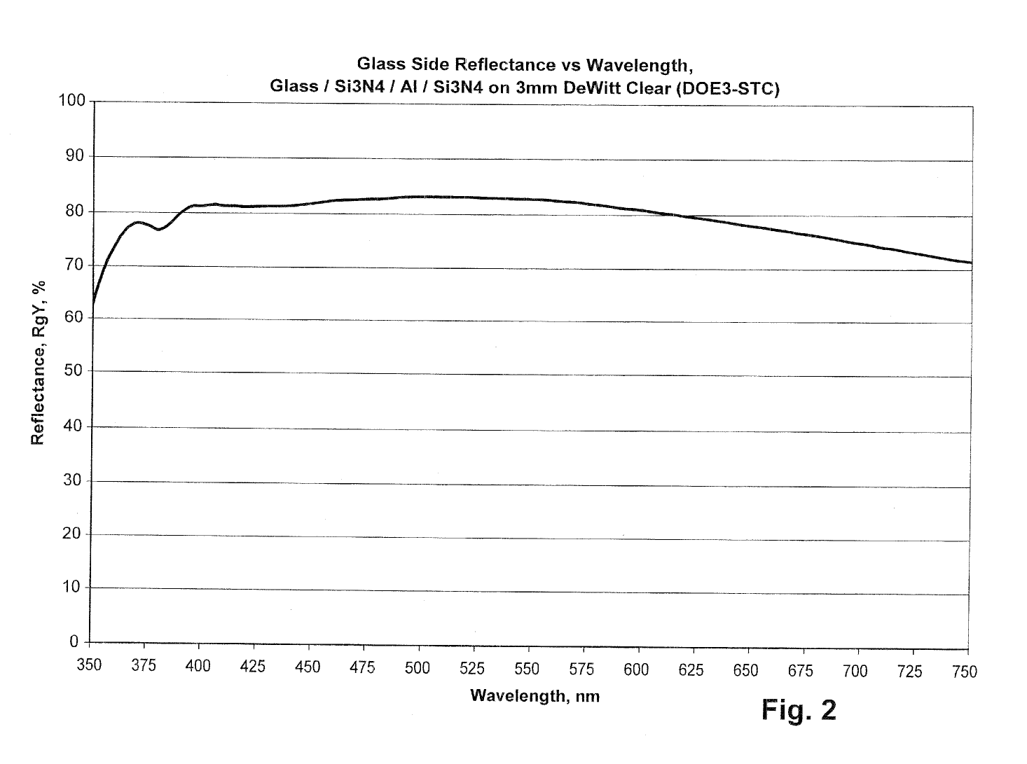

The FIG. 1a layer stack was coated on a 3.0 mm thick clear float glass substrate. The Al-based metallic layer 102 was 450 angstroms thick, and the first and second layers including silicon nitride or other dielectric material 104 and 106 were 40 angstroms thick and 80 angstroms thick, respectively. No PPF was provided in this sample. The glass side reflectance was measured with a Perkin-Elmer double beam spectrophotometer. The data was corrected to an NIST traceable standard over the visible wavelength range. Visible glass side reflectance was calculated using an Ill. ‘C’, 2 degree observer. With these parameters, glass side visible reflectance, RgY, was measured at 82.03%. FIG. 2 is a graph that plots glass side reflectance versus wavelength for the FIG. 1a example embodiment, assuming silicon nitride based dielectric layers, over the 350-750 nm wavelength range. It is noted that a thinner (e.g., 2.3 mm clear float) glass substrate would have result in slightly higher glass side reflectivity.

In FIGS. 1a and 1b, the Al-based metallic layer 102 preferably is 200-800 angstroms thick, more preferably 300-700 angstroms thick, and still more preferably 400-600 angstroms thick. Thickness ranges from 250-650 angstroms also are effective in certain example instances. The Al-based metallic layer 102 layer is primarily responsible for the very high reflectance in the visible (and near infrared) portion of the spectrum. At this thickness level, light transmission is reduced to about 1% over the visible and near infrared portion of the solar spectrum. The thickness of the Al-based metallic layer 102 may be increased or decreased to raise or lower reflectance, keeping all else equal. Certain example embodiments preferably provide a glass side reflectance (Ill. C/2 degrees) of >70%, more preferably >75%, with example reflectances of 77% and 82% being possible for different desired applications. Such reflectances may be measured on ˜2.3 mm (e.g., 2-3 mm) thick clear float glass substrates. It is noted that the provision of an Al-based layer between 250-360 angstroms, when applied to 3.0 mm clear float glass, can be used in connection with the techniques described herein to produce a glass side reflectance of about 78% with a light transmission of about 1.5%.

In FIG. 1a and/or FIG. 1b, the reflective layer 102 is metallic or substantially metallic. In FIG. 1a and/or FIG. 1b, first dielectric layer 104 (which is preferably sputter-deposited) may be of or include any of: silicon nitride (e.g., Si₃N₄) which may or may not be doped with aluminum, silicon oxide (e.g., SiO₂) which may or may not be doped with aluminum, silicon oxynitride which may or may not be doped with aluminum, aluminum oxide, aluminum oxynitride, zirconium oxide, titanium oxide, yittrium oxide (e.g., Y₂O₃), zinc oxide, zinc aluminum oxide, or tin oxide. Likewise, in FIG. 1a and/or FIG. 1b, second dielectric layer 106 (which is preferably sputter-deposited as preferably are layers 104, 102 and 1.1 0) may be of or include any of: silicon nitride (e.g., Si₃N₄) which may or may not be doped with aluminum, silicon oxide (e.g., SiO₂) which may or may not be doped with aluminum, silicon oxynitride which may or may not be doped with aluminum, aluminum oxide, aluminum oxynitride, zirconium oxide, titanium oxide, yittrium oxide (e.g., Y₂O₃), zinc oxide, zinc aluminum oxide, or tin oxide. First dielectric undercoat layer 104, which may be in contact with the glass 100, may have a thickness of less than 100 angstroms, with an example thickness of 40 angstroms. The use of a silicon nitride inclusive undercoat in SunGuard layer stacks has been shown to improve the chemical, environmental, and mechanical durability of the full stack compared to an otherwise identical layer stack that does not employ such an undercoat layer. The same has been shown in experiments for the aluminum mirror layer stack of certain example embodiments. That is, while aluminum generally adheres poorly to float glass, the addition of a very thin layer including silicon nitride or the like between the aluminum layer and the float glass improves adhesion dramatically.

However, maintaining the undercoat layer 104 thickness at less than 40 angstrom reduces the loss of visible reflectance of the overall layer stack while also maintaining the improvements in durability mentioned above. Thus, a thickness for layer 104 of from 10-200 angstroms, more preferably less than 100 angstroms, and sometimes even less than 40 angstroms, is desirable for layer 104 both for good adhesion and high reflectivity. In certain example embodiments, the layer 104 is preferably less than 100 angstroms thick, more preferably less than 75 angstroms thick, and still more preferably less than 50 angstroms thick.

A very thin Ni and/or Cr inclusive layer 110 optionally may be deposited after the Al-inclusive metal layer 102 to further improve overall durability. The thickness of this optional layer 110, when provided, preferably is between 1-150 angstroms, more preferably 1-50 angstroms, and still more preferably 5-20 angstroms. In general, a thickness of even 5-10 angstroms has been found to increase overall durability. The layer 110 comprising Ni and/or Cr also may help reduce the visible transmission to nearly 0%, possibly also improving visible reflectivity and also helping to adhere the Al-based layer 102 to the protective overcoat layer 106. The ratio of Ni-to-Cr may be 80/20, or any other suitable ratio. It is noted that a layer comprising NiCr may add complexity and expense, and may not always be necessary as the aluminum-based mirror layer stack can in some implementations be adequately protected by a permanent protective plastic film. Thus, certain example embodiments may omit a layer comprising Ni and/or Cr, e.g., when a PPF is provided, although these material are not necessarily mutually exclusive alternatives in all embodiments. It is noted that the layer comprising Ni and/or Cr may serve as an “environmentally protective layer” but also may help increase overall coating thickness in a manner that helps reduce light transmission (e.g., preferably below 3%, more preferably below 2%, and still more preferably below 1-1.5%, and possibly all the way to 0%). The layer 110 of or including Ni and/or Cr, may or may not be oxided or nitrided in different example embodiments. This may be advantageous because it may reduce the need to increase the thickness of the layer comprising aluminum and/or to provide an opaque PPF, e.g., in order to accomplish suitable visible light transmission reductions.

The second dielectric layer 106 is preferably 10-1000 angstroms thick, more preferably 10-200 angstroms thick, possibly 50-500 angstroms thick, and more preferably 70-200 angstroms thick. This layer may help provide mechanical, chemical, and environmental durability. It also may be much thicker than the undercoat dielectric layer 104, as its thickness will have little to no practical impact on glass side reflectivity of the mirror. In practice, a thickness of about 80 angstroms has been found to be sufficient to provide adequate overall durability at reasonable cost. It is noted that the thickness may be increased in the absence of PPF or decreased when PPF is present, although this need not always be the case, e.g., where further durability is desirable. In example embodiments, the thickness of the mirror coating, not including the PPF layer, may be from 300-2,000 angstroms thick.

Certain example embodiments may incorporate a permanent protective film (PPF) 108 with very high adhesion levels, very good chemical resistance, and/or excellent environmental durability The protective film may be resistant to delamination from moisture penetration and/or the use of asphalitic based adhesives applied to the exterior surface of the protective film. Adhesive strengths of the protective films are greater than or equal to 150 eN/20 mm wide strip, more preferably 275 cN/20 mm wide strip, as measured in the tape removal test. For instance, certain example embodiments may have an adhesive strength of 200-500 cN/20 mm wide strip, more preferably 200-300 cN/20 mm wide strip. Certain example embodiments may even have an adhesive peel strength of greater than or equal to about 320-430 eN/20 mm wide strip. The peel strength test used may be the peel strength test defined in EN 1939. Good abrasion resistance also is desirable, e.g., such that the there is no change in visible appearance when viewed from the glass side after the post-PPF coated article is wiped with a rubber material at a force of 250˜250 g, back and forth 20 times. In certain example embodiments, the PPF may be thin, e.g., having a thickness of <200 microns, and sometimes about 40-100 microns in thickness. Peel strength may be increased through the incorporation of additional cross-linking polymers in certain example embodiments.

The protective film 108 may also be relatively low in cost. To aid in manufacturing ease of setup, it would be desirable to use a permanent protective film that may be applied using the same equipment that is used to apply standard temporary protective films. Typical PPF protective films from Nitto-Denko include: SPV-9310, SPV-9320, SPV-30800, SPV 5057 A5, and SPV 5057 A7. Other manufacturers of similar preferred protective films that may be used for PPF 108 include Permacel, Tessa Tapes, B&K Films, and Novacell 9084 tape. These plastic films come in a wide variety of opacities and colors.

The PPFs of certain example embodiments preferably will pass environmental tests including, for example, high temperature-high humidity testing (e.g., at 49 degrees C. with 100% relative humidity), thermal cycling testing, and 85/85 testing (e.g., 85 degrees C. with 85% relative humidity). Standard ASTM tests may be performed to test for compliance, e.g., using 7 days exposure cycles. Salt fog exposure (e.g., to simulate oversees shipment) also may be tested for a 24-hour period. Permanent plastic films that do not blister or lose adhesion to the coated surface are preferred. Resistance to cutting oils and Windex also may be tested by soaking in such materials over 24 hour periods. These tests may be performed after the PPF is applied. PPFs that survive these tests are preferred because of their apparent durability and ability to withstand environmental conditions. In a similar vein, the thin film coating preferably does not delaminate after 3M 610 Scotch tape is applied thereto and removed therefrom.

It has been found that the addition of the permanent plastic protective films significantly enhances the safety of the final product. For example, as alluded to above, when a mirror is broken, pieces and shards of glass sometimes adhere very strongly to the protective film. The few remaining smaller pieces of the broken mirror that do not adhere to the protective film are far less likely to cause injury to anyone in the vicinity of the mirror when the mirror is broken.

Also as alluded to above, one advantage of plastic protective films compared to commercially available protective paints is the speed of application. In many current sputter coating facilities, for example, the typical roll applicator is able to apply the protective films at line speeds of 8.0 m/min. or greater. This is much faster than the typical process speed of 5.5 m/min. used to dry the paint in the painted mirror product. As was also previously mentioned, there is a reduced set of chemical safety issues related to the application of the protective film as compared to chemical paints.

A number of layer stacks in addition or as alternatives to the examples shown in FIGS. 1a and 1b are envisioned and can be produced on production sputtering machines at suitable line speeds. Certain of these example stacks are described in the following examples:

Example 1: glass/Si₃N₄ (40 angstroms)/Al (400 angstroms)/NiCr (50 angstroms)/Si₃N₄ (80 angstroms). RgY (C/2): 82.32%.

Example 2: glass/Si₃N₄ (40 angstroms)/Al (400 angstroms)/Cr (50 angstroms)/Si₃N₄ (80 angstroms). RgY (C/2): 81.83%. It will be appreciated that the presence of Ni together with Cr in the layer “behind” the Al improves reflectivity.

Example 3: glass/Si₃N₄ (40 angstroms)/NiCr (5 angstroms)/Al (400 angstroms)/NiCr (50 angstroms)/Si₃N₄ (80 angstroms). RgY (C/2): 78.87%. While the presence of a layer comprising Ni and/or Cr interposed between the Al and the glass substrate may help with adhesion, it nonetheless may reduce reflectance, possibly because of increased absorption on the part of the front layer comprising Ni and/or Cr.

Example 4: glass/Si₃N₄ (40 angstroms)/NiCr (5 angstroms)/Al (400 angstroms)/Cr (50 angstroms)/Si₃N₄ (80 angstroms). RgY (C/2): 78.83%.

Example 5: glass/Si₃N₄ (40 angstroms)/Al (400 angstroms)/NiCr (50 angstroms)/Si₃N₄ (80 angstroms)/PPF (Nitro-Denko SPV-9310). RgY (C/2): 82.32%.

Example 6: glass/Si₃N₄ (40 angstroms)/Al (400 angstroms)/Cr (50 angstroms)/Si₃N₄ (80 angstroms)/PPF (Nitto-Denko SPV-9310). RgY (C/2): 81.83%.

Example 7: glass/Si₃N₄ (40 angstroms)/NiCr (5 angstroms)/Al (400 angstroms)/NiCr (50 angstroms)/Si₃N₄ (80 angstroms)/PPF (Nitto-Denko SPV-9310). RgY (C/2): 78.87%.

Example 8: glass/Si₃N₄ (40 angstroms)/NiCr (5 angstroms)/Al (400 angstroms)/Cr (50 angstroms)/Si₃N₄ (80 angstroms)/PPF (Nitto-Denko SPV-9310). RgY (C/2): 78.83%.

Example 9: glass/Al (450 angstroms)/Si₃N₄ (80 angstroms). RgY (C/2): 84.06%. Although reflectivity was very high, adherence to the substrate is potentially compromised because the Al is in direct contact with the glass. Sodium migration from the underlying substrate may also negatively impact the quality of the Al over time.

Example 10: glass/Si₃N₄ (40 angstroms)/Al (450 angstroms)/Si₃N₄ (80 angstroms). RgY (C/2): 82.03%.

Example 11: glass/Si₃N₄ (40 angstroms)/Al (450 angstroms)/NiCr (5-10 angstroms)/Si₃N₄ (80 angstroms). RgY (C/2): 82.04%.

Example 12: glass/Al (450 angstroms)/Si₃N₄ (80 angstroms)/PPF (Nitro-Denko SFV-9310). RgY (C/2): 84.06%.

Example 13: glass/Si₃N₄ (40 angstroms)/Al (450 angstroms)/Si₃N₄ (80 angstroms)/PPF (Nitto-Denko SPV-9310). RgY (C/2): 82.03%.

Example 14: glass/Si₃N₄ (40 angstroms)/Al (450 angstroms)/NiCr (5-10 angstroms)/Si₃N₄ (80 angstroms)/PPF (Nitto-Denko SPV-9310). RgY (C/2): 82.04%.

It is noted that aluminum may be added to the silicon inclusive layers and/or the layers comprising Ni and/or Cr to help improve sputtering performance. Also, although certain example embodiments have been described as including sputter-deposited layers, it will be appreciated that some or all layers may be deposited by an alternate thin film deposition technique in different embodiments of this invention.

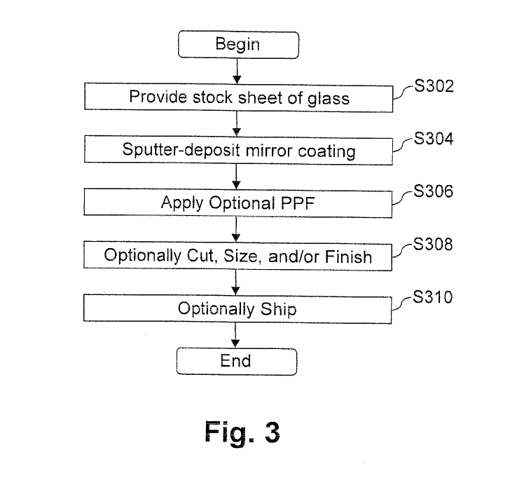

FIG. 3 is a flowchart illustrating an example process for making a mirror in accordance with certain example embodiments. A stock sheet of glass or glass substrate is provided in step S302. The glass substrate may be any suitable type of glass substrate, e.g., 1.0-10.0 mm thick, more preferably 1-5 mm thick, with example thicknesses of 2.0, 2.3, and 3.0 mm. The mirror coating is sputter deposited on a major surface (e.g., the surface designed to be the second major surface) of the substrate in step S304. Any of the above-described and/or other suitable layer stacks may be used in different embodiments of this invention. In step S306, a PPF is optionally applied, e.g., via a roll coater. The substrate may be cut, sized, and/or finished in step S308, and optionally shipped in step S310. In some cases, the finishing may include beveling, rounding, or chamfering edges, etc. Various washing and/or cleaning steps also may be performed. For instance, clear float glass may be washed prior to coating.

It will be appreciated that the steps need not be performed in the order shown in FIG. 3. For instance, a stock glass substrate may be coated and protected with PPF, shipped to a fabricator, and then optionally cut, sized, and/or finished by the fabricator, where it may then be built into a suitable protect (e.g., a bathroom mirror, decorative home or office mirror, etc.). In one or more steps not shown, the coating may be edge deleted, e.g., such that the PPF is applied directly onto the glass at edge portions. The edge deleted portions in such cases may be built into finished products such that the non-reflective areas are not visible. The PPF nonetheless may protect the entire back surface, although the mirror coating may be better protected because it does not go all the way to the outer edge of the substrate where it may be exposed inadvertently through manufacturing or installation processes that move the PPF, through normal side exposure of a few angstroms or nanometers, etc.

In some cases, a flat surface product may be sold. In other cases, the substrate may be bent (e.g., hot or cold bent) before or after the mirror coating and/or PPF is applied thereto.

In certain example embodiments, a mirror is provided. A multilayer thin film coating is supported by a substrate. The multilayer thin film coating comprises, in order moving away from the substrate: a first dielectric such as a silicon-inclusive layer, a metallic or substantially metallic layer comprising aluminum, a 5-150 angstrom thick layer comprising Ni and/or Cr in direct contact with the metallic or substantially metallic layer comprising aluminum, and a second dielectric such as a silicon-inclusive layer in direct contact with the layer comprising Ni and/or Cr. A protective film is disposed directly over and contacting an outermost layer of the multilayer thin film coating, with the protective film having a peel strength of 200-500 (e.g., 200-300 or 320-430) eN/20 mm wide strip. The protective film is adapted to survive seven day exposure to an 85 degree C. temperature at 85% relative humidity, as well as seven day exposure to a 49 degree C. temperature at 100% relative humidity.

In certain example embodiments, there is provided a coated article comprising a substrate and a multilayer thin film coating supported by the substrate. The multilayer thin film coating comprises a metallic or substantially metallic layer comprising aluminum sandwiched between inner and outer silicon-inclusive layers. A protective film is disposed directly over and contacting an outermost layer of the multilayer thin film coating.

In certain example embodiments, a method of making a coated article is provided. A coating comprising at least the following layers are sputter-deposited on a glass substrate in the following order: a first dielectric such as a silicon-inclusive layer, a metallic or substantially metallic layer comprising aluminum, and a second dielectric such as a silicon-inclusive layer. A protective film is applied directly over and contacting an outermost layer of the coating, with the protective film having a peel strength of 200-500 eN/20 mm wide strip.

Certain example embodiments relate to a method of making mirrors. The method may comprise, for example, receiving, at a fabricator location, a coated article made in accordance with any of the methods described herein; and cutting the coated article into pieces of one or more respective desired sizes in making the mirrors, with the pieces optionally having finished edges and/or the like.

In addition to the features of any of the previous four paragraphs, in certain example embodiments, as alluded to above, the protective film may have a peel strength of 200-500 cN/20 mm wide strip.

In addition to the features of any of the previous five paragraphs, in certain example embodiments, as alluded to above, the protective film is capable of surviving seven day exposure to an 85 degree C. temperature at 85% relative humidity, as well as seven day exposure to a 49 degree C. temperature at 1 00% relative humidity, e.g., with no evidence of delamination of the protective film and no evidence of deterioration of the coating.

In addition to the features of any of the previous six paragraphs, in certain example embodiments, as alluded to above, a layer comprising Ni and/or Cr may be interposed between the metallic or substantially metallic layer comprising aluminum and the outer dielectric. The layer optionally may be NiCr, and/or optionally may be 5-150 angstroms thick, e.g., as alluded to above. In some example cases, when the layer comprising NiCr is 5-20 angstroms thick, the protective film may be opaque. In other example cases, when the layer comprising NiCr is 50-150 angstroms thick, the protective film may be transparent (e.g., so as to lower tranmission through the substrate to less than 1-1.5%.

In addition to the features of any of the previous seven paragraphs, in certain example embodiments, the inner and outer dielectric layers may each comprise silicon nitride.

In addition to the features of any of the previous eight paragraphs, in certain example embodiments, the inner and outer dielectric (e.g., silicon-inclusive) layers may be less than 100 angstroms thick and 70-200 angstroms thick, respectively, and/or the metallic or substantially metallic layer comprising aluminum may be 250-650 (e.g., 400-600) angstroms thick.

In addition to the features of any of the previous nine paragraphs, in certain example embodiments, the coated article may have a glass side reflectance of at least 76%.

In addition to the features of any of the previous ten paragraphs, in certain example embodiments, the coated article may have a glass side reflectance of at least 82%.

Although certain example embodiments have been referred to as including “permanent protective films,” it will be appreciated that the word “permanent” should not be read in a strictest or literal sense. Rather, any film that is capable of surviving the above-described and/or other equivalent tests may be considered a “permanent” protective film. Similarly, any film that can survive the expected lifetime of the overall product may be considered sufficiently “permanent” to comply with the way that that word is used herein.

While a layer, layer system, coating, or the like, may be said to be “on” or “supported by” a substrate, layer, layer system, coating, or the like, other layer(s) may be provided therebetween, Thus, for example, the coatings or layers described above may be considered “on” and “supported by” the substrate and/or other coatings or layers even if other layer(s) are provided therebetween.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A mirror, comprising:
a glass substrate;
a multilayer thin film coating supported by the substrate, the multilayer thin film coating comprising, in order moving away from the substrate:
a first dielectric layer,
a metallic or substantially metallic layer comprising aluminum, and
a second dielectric layer; and
a protective film disposed directly over and contacting an outermost layer of the multilayer thin film coating, the protective film having a peel strength of 200-500 cN/20 mm wide strip,
wherein the protective film is adapted to survive seven day exposure to an 85 degree C. temperature at 85% relative humidity, as well as seven day exposure to a 49 degree C. temperature at 100% relative humidity.

2. A mirror comprising:
a substrate;
a multilayer thin film coating supported by the substrate, the multilayer thin film coating comprising a metallic or substantially metallic layer comprising aluminum sandwiched between inner and outer dielectric layers, the inner dielectric layer being located between at least the substrate and the metallic or substantially metallic layer comprising aluminum; and
a protective film disposed directly over and contacting an outermost layer of the multilayer thin film coating.

3. The mirror of claim 2, wherein the protective film has a peel strength of 200-500 cN/20 mm wide strip.

4. The mirror of claim 2, wherein the protective film is capable of surviving seven day exposure to an 85 degree C. temperature at 85% relative humidity, as well as seven day exposure to a 49 degree C. temperature at 100% relative humidity.

5. The mirror of claim 2, wherein a layer comprising Ni and/or Cr is interposed between the metallic or substantially metallic layer comprising aluminum and the outer dielectric layer.

6. The mirror of claim 2, wherein the inner and outer dielectric layers each comprise silicon nitride.

7. The mirror of claim 2, wherein the inner dielectric layer is less than 100 angstroms thick.

8. The mirror of claim 2, wherein a layer comprising NiCr is interposed between the metallic or substantially metallic layer comprising aluminum and the outer dielectric layer, and wherein the layer comprising NiCr is 5-20 angstroms thick.

9. The mirror of claim 2, wherein the coated article has a glass side reflectance of at least 76%.

10. The mirror of claim 2, wherein the metallic or substantially metallic layer comprising aluminum is 250-650 angstroms thick.

11. The mirror of claim 2, wherein the first dielectric layer comprises material selected from one or more of: silicon nitride, silicon oxynitride, aluminum oxide, aluminum oxynitride, zirconium oxide, titanium oxide, yittrium oxide, zinc aluminum oxide, and tin oxide.

12. The mirror of claim 2, wherein the second dielectric layer comprises material selected from one or more of: silicon nitride, silicon oxynitride, aluminum oxide, aluminum oxynitride, zirconium oxide, titanium oxide, yittrium oxide, zinc aluminum oxide, and tin oxide.

13. The mirror of claim 2, wherein the first and second dielectric layers each comprise material selected from one or more of: silicon nitride, silicon oxynitride, aluminum oxide, aluminum oxynitride, zirconium oxide, titanium oxide, yittrium oxide, zinc aluminum oxide, and tin oxide.

14. The mirror of claim 2, wherein the first and/or second dielectric layer(s) comprises silicon oxynitride.

15. The mirror of claim 2, wherein the first and/or second dielectric layer(s) comprises zirconium oxide.

16. The mirror of claim 2, wherein the first and/or second dielectric layer(s) comprises aluminum oxynitride.

17. The mirror of claim 2, wherein the outer dielectric layer is from 10-200 angstroms thick.

18. A method of making a mirror, the method comprising:
sputter-depositing on a glass substrate a coating comprising at least the following layers in the following order:
a first dielectric layer,
a metallic or substantially metallic layer comprising aluminum, and
a second dielectric layer; and
applying a protective film directly over and contacting an outermost layer of the coating, the protective film having a peel strength of 200-500 cN/20 mm wide strip.

19. The method of claim 18, wherein the protective film is adapted to survive seven day exposure to an 85 degree C. temperature at 85% relative humidity, as well as seven day exposure to a 49 degree C. temperature at 100% relative humidity, with no evidence of delamination of the protective film and no evidence of deterioration of the coating.

20. The method of claim 18, further comprising:
receiving, at a fabricator location, a coated article made in accordance with the method of claim 18; and
cutting the coated article into pieces of one or more respective desired sizes for making mirrors.
